(19) United States
(12) Patent Application Publication
(10) Pub. No.: US 2019/0234452 A1
(43) Pub. Date: Aug. 1, 2019

(54) CABLE ADJUSTMENT MECHANISM

(71) Applicant: Magna Closures Inc., Newmarket (CA)

(72) Inventors: Adrian Mihail, Richmond Hill (CA); Michal Ruzicka, Stouffville (CA)

(21) Appl. No.: 16/264,910

(22) Filed: Feb. 1, 2019

Related U.S. Application Data
(60) Provisional application No. 62/625,008, filed on Feb. 1, 2018.

(51) Int. Cl. F16C 1/22

(52) U.S. Cl. CPC F16C 1/226

(57) ABSTRACT

A cable adjustment mechanism for connecting a cable assembly comprising a cable to a bracket, the mechanism comprising: a connecting bushing having a bracket connector for attaching to the bracket, a first body interior for receiving the cable there though, and a cable connector for attaching to the a mechanism body of the cable assembly; the mechanism body having a second body interior for receiving the cable there though, a first end, and a second end for receiving the connecting bushing, the first end opposed to the second end, the second body interior defining an adjustment axis; a spacing member having one end for coupling to a cable body of the cable assembly and another end for coupling with the mechanism body at the first end, the another end opposed to the one end, the spacing member having a third body interior for receiving the cable there through; and a lock for retaining a selected relative position on the mechanism body along the adjustment axis in order to retain a resultant separation distance between the connecting bushing and the cable body; wherein the selected relative position is determined by adjusting a position of the coupling of the one end with respect to the first end along the adjustment axis prior to locking the selected relative position by the lock.

### CROSS-REFERENCE TO RELATED APPLICATIONS

The present application claims priority from U.S. Provisional Patent Application No. 62/625,008, filed on Feb. 1, 2018; the entire contents of which are hereby incorporated by reference herein.

### FIELD

The present invention is related to tension adjustment mechanisms for cables.

### BACKGROUND

Current solutions used to attach cables use a regular cable end bushing and a cable adjuster located in the middle of the cable. This existing solution is not preferred, due to the number of component pieces resulting in an increased piece price costing and complexity in manufacturability due to, at least in part, a required assembly/configuration process with multiple cable portions, the cable end bushing with one cable portion and a support bracket, and the cable adjuster spliced into further cable portions. In particular, the use of multiple cable portions associated with the cable end bushing and the cable adjuster also increases the complexity required for cable tension adjustment.

### SUMMARY

It is an object to the present invention to provide a cable adjustment mechanism to obviate or mitigate at least one of the disadvantages of current cable adjustment mechanisms.

A further object of the invention is to simplify and/or improve adjustment of synchronous release when more than one release device is used.

A first aspect provided is a cable adjustment mechanism for connecting a cable assembly comprising a cable to a bracket, the mechanism comprising: a connecting bushing having a bracket connector for attaching to the bracket, a first body interior for receiving the cable there though, and a cable connector for attaching to the a mechanism body of the cable assembly; the mechanism body having a second body interior for receiving the cable there though, a first end, and a second end for receiving the connecting bushing, the first end opposed to the second end, the second body interior defining an adjustment axis; a spacing member having one end for coupling to a cable body of the cable assembly and another end for coupling with the mechanism body at the first end, the another end opposed to the one end, the spacing member having a third body interior for receiving the cable there through; and a lock for retaining a selected relative position on the mechanism body along the adjustment axis in order to retain a resultant separation distance between the connecting bushing and the cable body; wherein the selected relative position is determined by adjusting a position of the coupling of the one end with respect to the first end along the adjustment axis prior to locking the selected relative position by the lock.

A second aspect provided is a method for operating a cable adjustment mechanism for connecting a cable assembly comprising a cable to a bracket, the method comprising the steps of: attaching a connecting bushing having a bracket connector to the bracket, the connecting bushing having a first body interior for receiving the cable there though; attaching a cable connector of the connecting bushing to a mechanism body of the cable assembly, the mechanism body having a second body interior for receiving the cable there though, a first end, and a second end for receiving the connecting bushing, the first end opposed to the second end, the second body interior defining an adjustment axis; coupling a spacing member at one end to a cable body of the cable assembly and coupling at another end with the mechanism body at the first end, the another end opposed to the one end, the spacing member having a third body interior for receiving the cable there through; and positioning a lock for retaining a selected relative position on the mechanism body along the adjustment axis in order to retain a resultant separation distance between the connecting bushing and the cable body; wherein the selected relative position is determined by adjusting a position of the coupling of the one end with respect to the first end along the adjustment axis prior to locking the selected relative position by the lock.

### BRIEF DESCRIPTION OF THE DRAWINGS

Reference is made, by way of example only, to the attached figures, wherein:

FIG. 1 is an existing solution for a prior art cable adjuster;

FIG. 2 is a perspective view of a vehicle;

FIG. 3 is an assembled view of a cable adjustment mechanism for mounting in the vehicle of FIG. 2;

FIG. 4 is an unassembled view of the cable adjustment mechanism of FIG. 3;

FIG. 5 is a cross sectional view of the mechanism body of the cable adjustment mechanism shown in FIG. 3 and

FIG. 6 is an example operation of the cable adjustment mechanism of FIG. 3.

### DESCRIPTION

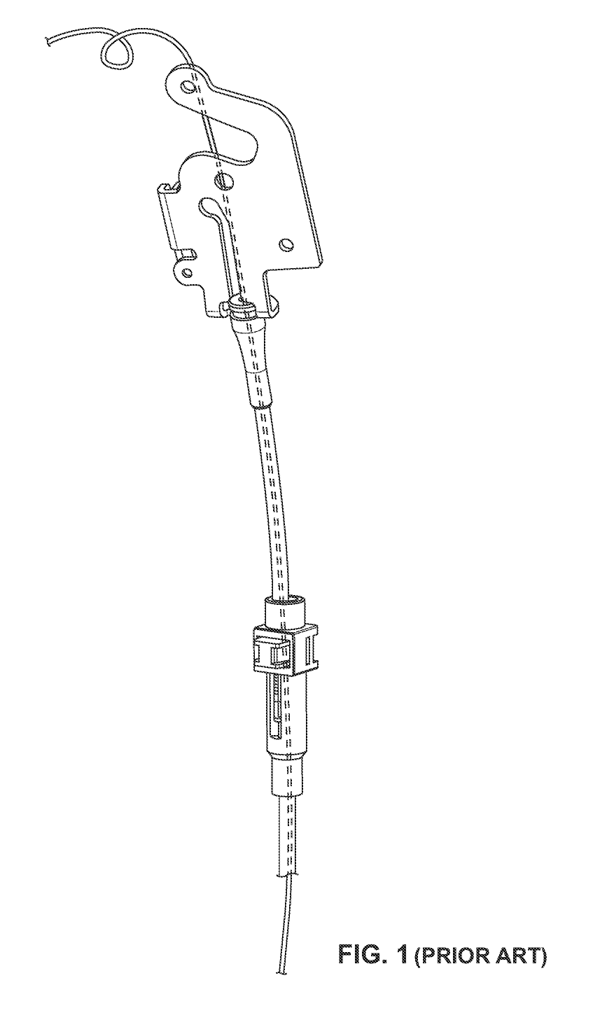

Referring to FIG. 1, shown is prior art of a cable adjuster used to attach a cable to a bracket via a regular cable end bushing and a cable adjuster located in the middle of the cable. This existing solution is not preferred, due to the number of component pieces resulting in an increased piece price costing and complexity in manufacturability due to, at least in part, a required assembly/configuration process with the multiple cable portions, the cable end bushing with one cable portion and a support bracket, and the cable adjuster spliced into further cable portions. In particular, the use of multiple cable portions associated with the cable end bushing and the cable adjuster also increases the complexity required for cable tension adjustment.

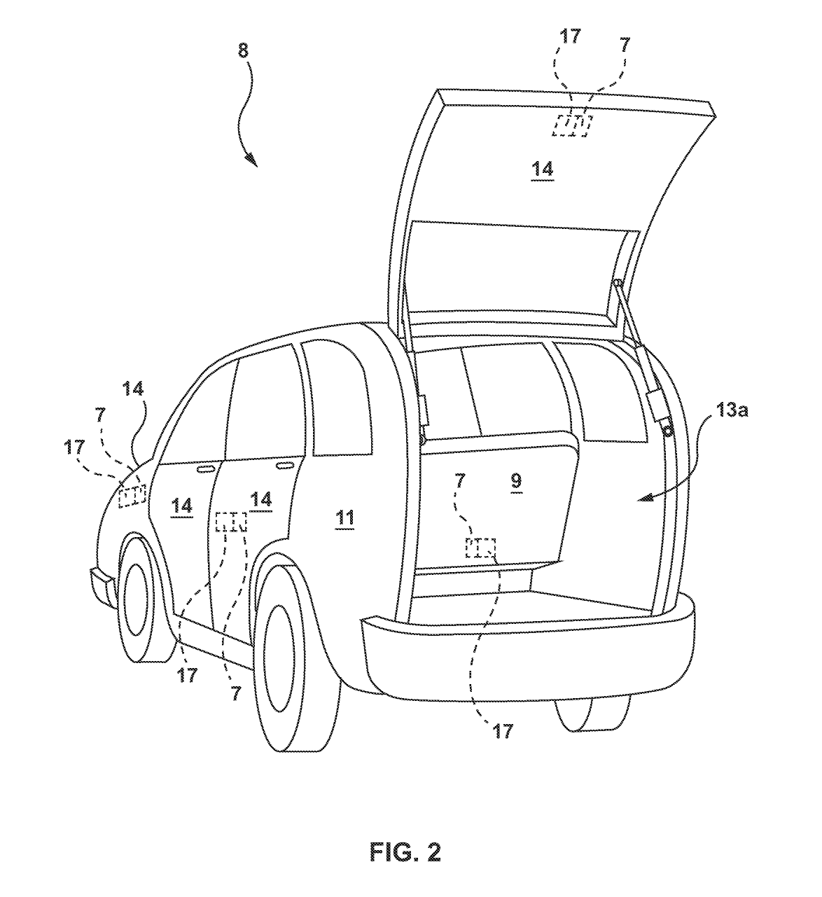

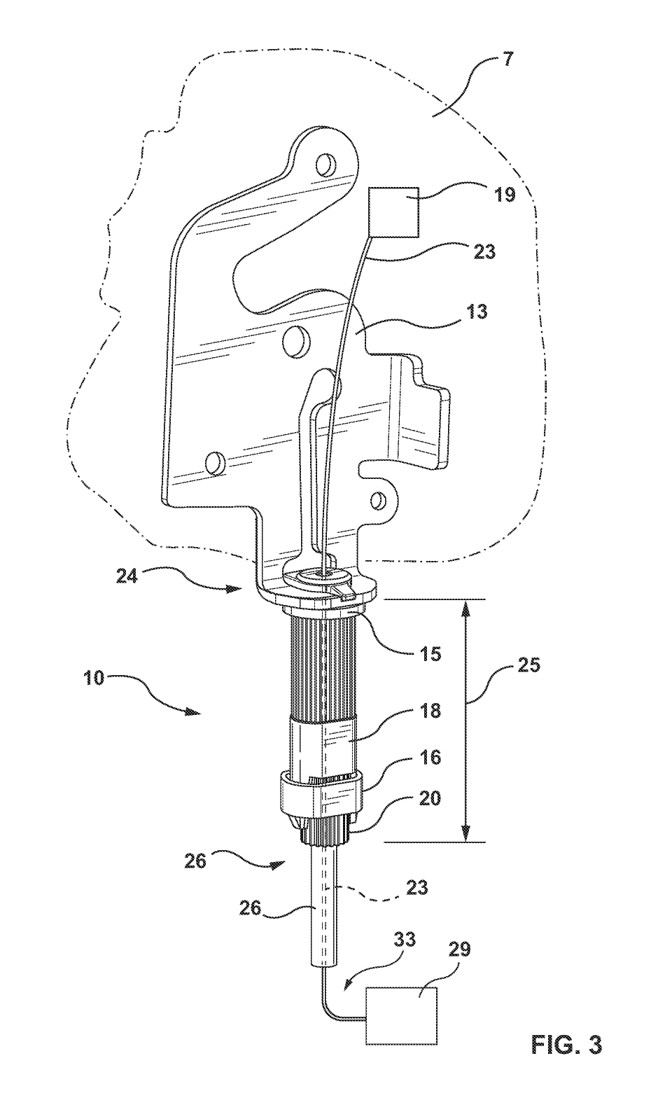

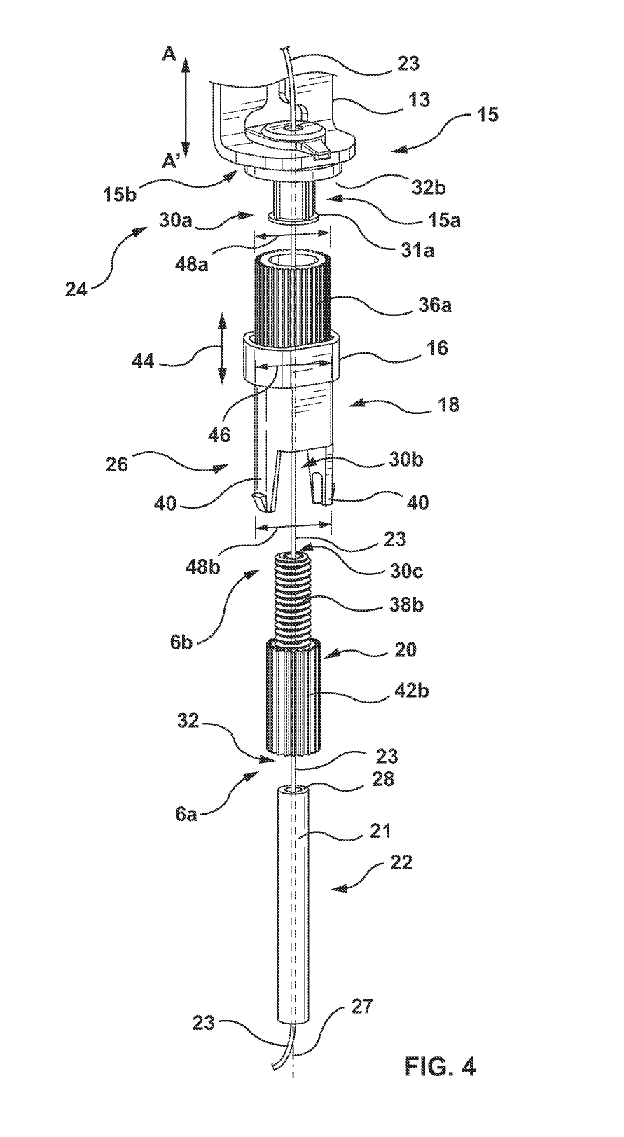

Referring to FIGS. 3 and 4, shown is a cable adjustment mechanism 10 for use in attaching and subsequent tension adjustment of a cable assembly 22 connected to a frame 7 coupled to a vehicle body 11, a closure panel 14, a seat 9, a lock/latch 17, etc.—see FIG. 2. The cable assembly 22 has a cable body 21 housing a cable 23 (e.g. a metal wire) within. The cable 23 is slidably received through components of the cable adjustment mechanism 10 to actuate a component 19 to which it is operably connected to by slideable activation in directions A-A′ of the cable 23 at its opposite end to the operable connection with the component 19. In one example, the component 19 may be a pawl or release lever of a vehicle door latch (all not shown). The cable body 21, acting as a conduit for the cable 23 to guide and protect the cable 23, is indirectly connected to a connecting bushing 15 situated at one end 24 of the cable adjustment mechanism 10 by connection of the cable body 21 to a spacing member 20 situated at an opposing end 26 of the cable adjustment mechanism 10. Further, a mechanism body 18 is interposed between the one end 24 and the opposing end 26, such that the spacing member 20 positioned within the mechanism body 18.

The cable adjustment mechanism 10 can be coupled to a bracket 13 (for connecting to or otherwise part of the frame 7), via the connecting bushing 15 for anchoring the cable adjustment mechanism 10 to the bracket 13. The cable adjustment mechanism 10 also has cooperating adjuster components of the mechanism body 18 coupled to the connecting bushing 15 at the one end 24, the spacing member 20 for coupling to the cable body 21 at the opposing end 26, and a lock 16 for maintaining a separation distance 25 between the ends 24,26 (i.e. spacing) along an adjustment axis 27 (see FIG. 4). As further described below, the separation distance 25 between an end 28 of the cable body 21 and the connecting bushing 15 is reflective of the tension applied to the cable 23. By increasing the separation distance 25, the length of the cable 23 protruding from the connecting bushing 15 can be decreased by increasing the effective length of the cable body 21 that the cable 23 has to occupy i.e. adding tension. By decreasing the separation distance 25, the length of the cable 23 protruding from the connecting bushing 15 can be increased by decreasing the effective length of the cable body 21 that the cable 23 has to occupy i.e. reducing tension. The axial positioning of the mechanism body 18 with respect to the spacing member 20, as maintained by the lock 16, provides for the separation distance 25 and thus the tension applied to the cable 23.

Provided is the adjustment mechanism 10 that can be used advantageously to tension the cable 23 (i.e. increase or decrease the effective length of the cable body 21), while at the same time can help reduce complexity by combining different parts (i.e. the connecting bushing 15 with the adjuster components of the lock 16, mechanism body 18, and spacing member 20) with different functionalities in one single adjustment mechanism 10. The proposed combination of connection to the bracket 13 with tension adjustment ability of the cable 23 can facilitate a reduction in piece price costing and improvements in manufacturability due to, at least in part, a simplified assembly/configuration process between the cable assembly 22 and the bracket 13. In particular, removing any intervening cable body 21 situated between the mechanism body 18 and the connecting bushing 15 (i.e. thereby having direct contact between the connecting bushing 15 and the mechanism body 18) facilitates the simplified assembly/configuration process of connecting the adjustment mechanism 10 to the bracket 13 (and ultimately the frame 7) while at the same time facilitating the tension adjustment process of the cable 23.

Referring again to FIG. 2, shown is an exemplary vehicle 8 with the vehicle body 11 having one or more closure panels 14. For vehicles 8, the closure panel 14 can be referred to as a partition or door, typically hinged, but sometimes attached by other mechanisms such as tracks, in front of an opening 13a which is used for entering and exiting the vehicle 8 interior by people and/or cargo. It is also recognized that the closure panel 14 can be used as an access panel for vehicle 8 systems such as engine compartments (e.g. vehicle hood 14) and also for traditional trunk compartments (i.e. a vehicle storage compartment 14) of automotive type vehicles 8. The closure panel 14 can be opened to provide access to the opening 13a, or closed to secure or otherwise restrict access to the opening 13a. In terms of vehicles 8, the closure panel 14 may be the lift gate as shown in FIG. 2, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 13a in the body 11 of the vehicle 8. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening 13a for equipment to be loaded and unloaded through the opening 13a without obstructing access. The interior of the vehicle 8 can include adjustable seats 9. It is recognized that the cable adjustment mechanism 10 (see FIG. 3) can be utilized in the vehicle 8 in association with one or more mechanisms of the lock/latch 17 (e.g. a hood latch 17 arrangement, a lift gate latch 17 arrangement, a door latch 17 arrangement, and/or a seat latch 17 arrangement, for example). For example, actuation of the cable 23 by an operator (not shown) acting on a handle 29 (e.g. door handle)—see FIG. 3) of the vehicle 8 can be used to actuate the lock/latch 17 coupled to the adjustment mechanism 10 (e.g. via the bracket 13).

Referring to FIG. 4, the connecting bushing 15 has a cable connector 15a (e.g. a mechanical crimp connection) for fixedly connecting to the mechanism body 18, either being over moulded there within or welded there within using ultrasonic welding techniques for example, such that the mechanism body 18 is affixed to the connecting bushing via the cable connector 15a. The cable 23 is threaded through respective body interiors 30a,b,c of the mechanism body 18 and the spacing member 20 and the connecting bushing 15. The connecting bushing 15 also has a bracket connector 15b for anchoring the adjustment mechanism 10 to the bracket 13. In the illustrated embodiment, the bracket 13 can have a upstanding projection with a receiving slot, while bracket connector 15b includes a protruding annular flange and annular body, with the annular body being received with the slot and the protruding annular flange abutting the upstanding projection when the slot is so received to prevent the annular body from disengaging the slot in predetermined directions. As such, once affixed to both the mechanism body 18 and the bracket 13, the connecting bushing 15 connects the adjustment mechanism 10 to the bracket 13.

Referring again to FIG. 4, the spacing member 20 has a cable body connector 32 (e.g. a receptacle) for housing the end 28 of the cable body 21 (of the cable assembly 22). The cable body 21 may be over moulded there within or welded there within using ultrasonic welding techniques for example. Once the cable body 21 is connected to the adjustment mechanism 10 via the cable body connector 32, changes to the relative axial positioning of the mechanism body 18 and the spacing member 20 along the adjustment axis 27 would result in adjustments in the tension experienced by the cable 23, which is threaded through the body interiors 30a,b,c of the adjuster components (i.e. of the lock 16, mechanism body 18, and spacing member 20). While illustratively the cable 23 is shown to be threaded through the body interiors 30a,b,c of the of the lock 16, mechanism body 18, and spacing member 20, and terminate at a fixed connection (e.g. fixedly attached to a component of the lock/latch 17) of the component 19, the cable 23 may terminate at the connection with the connecting bushing 15, such that changes to the relative axial positioning of the mechanism body 18 and the spacing member 20 would result in adjustments in the tension experienced by the cable 23 at its opposite activation end 33 (e.g. coupled to the handle 29).

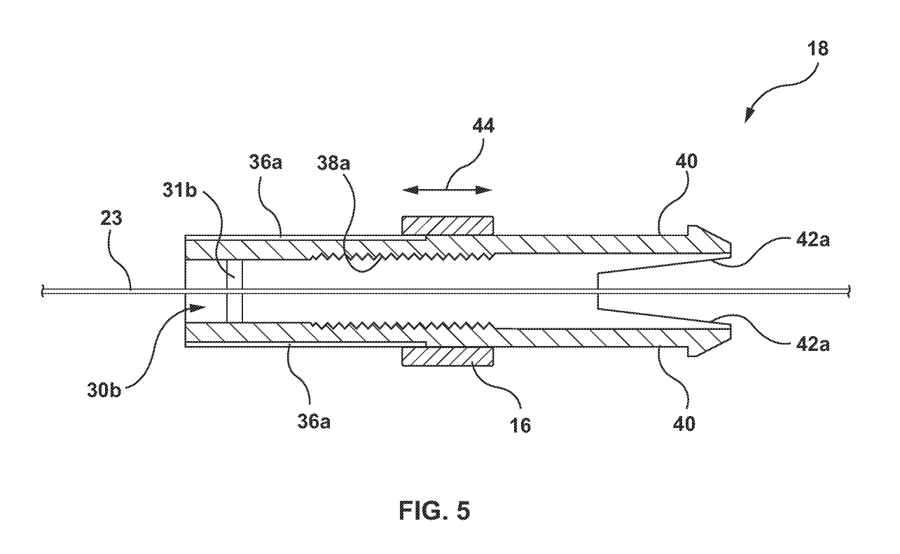

Referring to FIG. 5, the mechanism body 18 can have a series of splines 36a for gripping with fingers or a tool for example. The mechanism body 18 further includes a connection interface 31a, 31b for coupling with the connecting bushing 15 (e.g. via a snap or press fit with a protruding tab 31a in connection with a slot 31b—see FIGS. 4, 5) positioned on the cable connector 15a, so as to allow rotation of the mechanism body 18 about the adjustment axis 27 when adjusting the position of the spacing member 20 with respect to the mechanism body 18. This can facilitate the mechanism body 18 to be rotatable relative to the connecting bushing 15 and the spacing member 20 in the event the cable 23 is fixed and non-rotatable. The mechanism body 18 can also have threads 38a situated in the body interior 30b for mating/coupling with threads 38b (see FIG. 4) of the spacing member 20, once the threads 38b are inserted in the body interior 30b of the mechanism body 18 (see FIG. 3). As such, mating of the threads 38a,b (via rotation of the spacing member 20 about the adjustment axis 27) provides for an adjustable coupling between the mechanism body 18 and the spacing member 20, while at the same time facilitates adjustment in the relative axial positioning between the mechanism body 18 and the spacing member 20 along the adjustment axis 27.

The mechanism body 18 also has a pair of prongs 40, which are resiliently connected at the opposing end 26 thereto. The prongs 40 can have a series of splines 42a (facing inwards towards the adjustment axis 27) for coupling with splines 42b of the spacing member 20 (projecting outwards with respect to the adjustment axis 27—see FIG. 3). Once the lock 16 is fixedly (but also releasably) engaged with the prongs 40 (i.e. the lock 16 is movable between an unlocked position and a locked position along the adjustment axis 27), the splines 42a, b are forced into engagement with one another such that relative movement about the adjustment axis 27 between the splines 42a, b is restricted. As such, once fixedly (but releasably) engaged in the locked position (see FIG. 3), the lock 16 causes the splines 42a,b to fixedly engage with one another and thereby restrict further rotation of the spacing member 20 about the adjustment axis 27. Restricting rotation of the spacing member 20 results in fixing the set tension of the cable 23, i.e. fixing the separation distance 25 between the ends 24,26). When the lock 16 is not fixedly engaged with the prongs 40, i.e. the lock 16 is in the unlocked position—see FIG. 4, the prongs 40 can still be resiliently biased towards the splines 42a with a residual force so as to facilitate a ratcheting or clicking action with the splines 42b (i.e. the action of the splines 42a, b upon one another, such that when not fixedly engaged with the lock 16, can urge the prongs 40 to deflect away from one another so that adjacent splines 42a, b may slip by their peaks and engage their valleys upon their relative rotation), between the mechanism body 18 and the spacing member 20 upon relative rotation of one another about the adjustment axis 27, thereby facilitating a stepped or incremental fine tuning of the separation distance 25 and thus the tension and a maintaining thereof subsequent such fine tuning (i.e. while the lock 16 is in the unlocked position along the adjustment axis 27). The subsequent fixed engagement of the lock 16 with the prongs 40 (once the separation distance 25 is set and the lock 16 is put in the locked position towards the opposing end 26) further provides that the prongs 40 remain in fixed engagement with the splines 42b despite any experienced vibration or temperature variations of the adjustment mechanism 10 during its use, as well as any induced potential relative movement between the spacing member 20 and the body mechanism 18 about the adjustment axis 27. Thus the adjustment mechanism 10 provides for a fine tuning of the cable 23 tension (when the lock 16 is positioned in the unlocked position—i.e. positioned away from the opposing end 26 and out of engagement with the prongs 40), as well as a locking of such tension (when the lock 16 is positioned in the locked position—i.e. positioned towards the opposing end 26 and into engagement with the prongs 40) after fine tuning in a manner that can be simple and robust. As such, it is recognized that the lock 16 can be positioned away from the opposing end 26 (i.e. the unlocked position) to provide for limited/slip relative movement between the splines 42a,b about the adjustment axis 27, or the lock 16 can be positioned towards/at the opposing end 26 (i.e. the locked position) to restrict any limited/slip relative movement between the splines 42a,b about the adjustment axis 27.

In operation, the lock 16 is slidable 44 along the adjustment axis 27, for example about a periphery of the mechanism body 18, such that the axial position of the lock 16 in FIG. 4 denotes that the splines 42a,b are not in the fixed, locked engagement while the axial position of the lock 16 in FIG. 3 denotes that the splines 42a,b are in the fixed, locked engagement. An interior dimension 46 (e.g. diameter) of the lock 16 is greater than an exterior dimension 48a of the mechanism body 18 near the splines 36a of the one end 24, thus providing for relative axial movement between the lock 16 and the mechanism body 18. On the contrary, the interior dimension 46 (e.g. diameter) of the lock 16 is slightly less than an exterior dimension 48b of the mechanism body 18 near the prongs 40 at the opposing end 26, thus providing for further compression of the prongs 40 towards the adjustment axis 27 of the body interior 30b of the mechanism body 18 and thus promoting fixed engagement of the splines 42a,b, once the lock 16 is moved onto the prongs 40. For example, the lock 16 can be movable along the adjustment axis 27 from the one end 24 towards the opposing end 26 until positioned firmly over the prongs 40 (see FIG. 3), whereby bending of the prongs 40 towards the body interior 30b of the mechanism body 18 firmly (e.g. via a friction fit) positions the lock 16 on the mechanism body 18, and thus fixedly locks or otherwise engages the splines 42a,b with one another in order to restrict further relative movement between the splines 42a,b. In the locked position, the engagement of the lock 16 with the prongs 40 causes the prongs 40 to be bent towards the adjustment axis 27, due to the fact that the exterior dimension 48b is greater than the interior dimension 46.

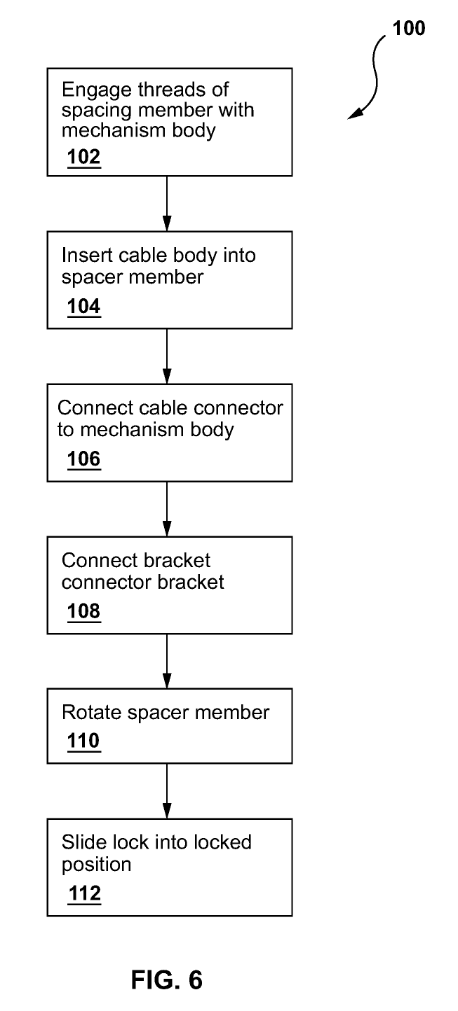

Referring to FIGS. 2 to 6, in operation 100 of the adjustment mechanism 10, initial assembly is performed by engaging 102 threads 38b of the spacing member 20 with the threads 38a of the mechanism body 18, such that the prongs 40 are positioned adjacent to the opposing end 26 of the mechanism body 18, thereby mechanically coupling the spacing member 20 to the mechanism body 18. Next, the cable body 21 is inserted 104 into the cable body connector 32 of the spacing member 20 and the cable 23 is inserted through the body interiors 30a,b,c of the spacing member 20 and the mechanism body 18 and into the connecting bushing 15. The cable connector 15a (of the connecting bushing 15) is connected 106 to the mechanism body 18 and then the bracket connector 15b is connected 108 to the bracket 13 at the one end 24 of the mechanism body 18. In one option, connection of the cable connector 15a to the mechanism body 18 can engage splines 36a with a set of splines 32b (in the body interior 30a of the connecting bushing 15) with one another, thus inhibiting relative rotation between the connecting bushing 15 and the mechanism body 18. Alternatively, in a second option, the mechanism body 18 and the connecting bushing 15 may be press fitted together to allow a relative rotation there between, such that the connection interface 31a,b is utilized as described above. In any event, once the adjustment mechanism 10 is assembled initially, in this setting, the separation distance 25 between the ends 24,26 is such that the tension of the cable 23 is less than desired (e.g. at a minimum or zero). Further, at this stage, the operable connection of the cable 23 is confirmed/made with the component 19.

In order to adjust the tension of the cable 23, in one embodiment, the spacing member 20 can be rotated 110 about the adjustment axis 27, thereby increasing the separation distance 25 between the ends 24,26 and thus the effective length of the cable body 21. As the separation distance 25 increases, the tension in the cable 23 also increases as the cable 23 of the cable assembly 22 occupies the increase in the space within the mechanism body 18 and the spacing member 20, due to the increase in the separation distance 25, while the cable body 21 of the cable assembly 22 is held in the cable body connector 32 at the other end 26. Once the desired tension of the cable 23 or desired length of the cable 23 protruding from the connecting bushing 15 is reached (i.e. as the relative axial position between the ends 24, 26 increases the tension of the cable 23 also increases as the protruding length decreases), the lock 16 is slid 112 over the exterior dimension 48a of the mechanism body 18, towards and onto the exterior dimension 48b of the prongs 40. It is recognized that as the spacing member 20 is rotated, conjoint rotation of the mechanism body 18 can be inhibited by interaction between the splines 36a, 36b. Subsequent forcing of the lock 16 onto the prongs 40 causes the prongs 40 to bend inwards towards the adjustment axis 27 and thus fixedly engage the splines 42a,b to restrict the splines 42a, b from slipping past each other. Once the splines 42a,b are restricted in relative movement with one another, further relative rotation between the mechanism body 18 and the spacing member 20 is restricted and thus the set tension of the cable 23 is maintained as long as the positioning of the lock 16 inhibits further relative rotational movement between the mechanism body 18 and the spacing member 20.

As discussed above, it is recognized that the connecting bushing 15 can be rotatably connected to mechanism body 18, so the mechanism body 18 can be rotated about the adjustment axis 27 if the cable 23 is not rotatable. Alternatively, a fixed connection between the connecting bushing 15 and the mechanism body 18 can be provided in the example case where the cable 23 can be rotated about the adjustment axis 27, in which case the spacing member 20 is rotated about the adjustment axis 27 in order to adjust the separation distance 25. Further, the lock 16 (e.g. sleeve) can be slid along the mechanism body 18 towards the prongs 40 in order to secure the prongs 40 so that the prongs 40 are inhibited from deflecting away from another to facilitate a rotation of the spacing member 20 relative to the mechanism body 18 about the adjustment axis 27.

As discussed above, the cable adjustment mechanism 10 can be for connecting the cable assembly 22 to the frame 7, the mechanism including: the connecting bushing 15 having a bracket connector 15b for attaching to the frame 7, a first body (e.g. bushing) interior 30a for receiving the cable there though, and a cable connector 15a for attaching to the mechanism body 18 of the cable assembly 22; the mechanism body 18 having a second body interior 30b for receiving the cable 23 there though, a first end (e.g. opposing end 26) adjacent to the prongs 40, and a second end (e.g. one end 24) for receiving the connecting bushing 15, the first end opposed to the second end, the second body interior 30b defining the adjustment axis 27; the spacing member 20 having one end 6a (e.g. the cable body connector 32 adjacent to the splines 42b) for coupling to the cable body 21 of the cable assembly 22 and another end 6b (e.g. adjacent to the threads 38b) for coupling with the mechanism body 18 at the first end (e.g. opposing end 26), the another end 6b opposed to the one end 6a, the spacing member 20 having a third body interior 30c for receiving the cable 23 there through; and the lock 16 for retaining a selected relative position between the mechanism body 18 and the spacing member 20 along the adjustment axis 27 in order to define the resultant separation distance 25 between the connecting bushing 15 and the cable body 21; whereby the selected relative position is determined by adjusting a position of the coupling of the one end 6a with respect to the first end (e.g. opposing end 26) along the adjustment axis 27.

Further, it is recognized that the pair of resilient prongs 40 are situated at the first end (e.g. opposing end 26) of the mechanism body 18 about the adjustment axis 27, such that the spacing member 20 is positioned between the pair of resilient prongs 40 when the spacing member 20 is coupled to the mechanism body 18 (e.g. via mating of the threads 38a, b). Also, it is recognized that the lock 16 can be configured for compressing the resilient prongs 40 towards the adjustment axis 27 to restrict conjoint rotation of the mechanism body 18 and the spacing member 20 about the adjustment axis 27 in order to provide the fixedly retaining (and releasably) of the selected relative position providing the resultant separation distance 25.

We claim:

1. A cable adjustment mechanism for connecting a cable assembly comprising a cable to a bracket, the mechanism comprising:
a connecting bushing having a bracket connector for attaching to the bracket, a first body interior for receiving the cable there though, and a cable connector for attaching to the a mechanism body of the cable assembly;
the mechanism body having a second body interior for receiving the cable there though, a first end, and a second end for receiving the connecting bushing, the first end opposed to the second end, the second body interior defining an adjustment axis;
a spacing member having one end for coupling to a cable body of the cable assembly and another end for coupling with the mechanism body at the first end, the another end opposed to the one end, the spacing member having a third body interior for receiving the cable there through; and
a lock for retaining a selected relative position on the mechanism body along the adjustment axis in order to retain a resultant separation distance between the connecting bushing and the cable body;
wherein the selected relative position is determined by adjusting a position of the coupling of the one end with respect to the first end along the adjustment axis prior to locking the selected relative position by the lock.

2. The mechanism of claim 1 further comprising a pair of resilient prongs at the first end about the adjustment axis, such that the spacing member is positioned between the pair of resilient prongs.

3. The mechanism of claim 2, wherein the lock is sized for compressing the resilient prongs towards the adjustment axis to restrict conjoint rotation of the mechanism body and the spacing member about the adjustment axis in order to provide said retaining.

4. The mechanism of claim 1 further comprising the mechanism body having first splines at the second end for mating with second splines of the connecting bushing in order to inhibit relative rotation between the connecting bushing and the mechanism body.

5. The mechanism of claim 1 further comprising the mechanism body and the connecting bushing coupled to one another by a connection interface in order to facilitate relative rotation between the connecting bushing and the mechanism body.

6. The mechanism of claim 5, wherein the connection interface includes a tab and a slot.

7. The mechanism of claim 1, wherein an interior dimension of the lock is greater than an exterior dimension of the mechanism body at the second end, thus providing for relative axial movement between the lock and the mechanism body.

8. The mechanism of claim 1, an interior dimension of the lock is less than an exterior dimension of the mechanism body at the first end, thus restricting relative axial movement between the lock and the mechanism body when the lock is positioned at the first end.

9. The mechanism of claim 1, wherein the bracket is for connecting to a frame of a vehicle.

10. The mechanism of claim 9, wherein one end of the cable is connected to a component of the vehicle.

11. The mechanism of claim 10, wherein the component is a latch.

12. The mechanism of claim 2, wherein the pair of resilient prongs have a first set of splines biased towards a second set of splines on the spacer member.

13. The mechanism of claim 12, wherein the said biased provides a residual force so as to facilitate interaction of the first set of splines with the second set of splines as the spacer member is rotated relative to the mechanism body, when the lock is positioned away from the first end in an unlocked position.

14. The mechanism of claim 13, such that when the lock is positioned away from the first end in an unlocked position, said interaction of the first set of splines with the second set of splines includes urging of the pair of resilient prongs to deflect away from one another so that the first set of splines and the second set of splines slip by their peaks and engage their valleys as the spacer member is rotated relative to the mechanism body.

15. The mechanism of claim 1, wherein the lock is positioned about an exterior of the mechanism body, such that the lock is movable along the adjustment axis between an unlocked position and a locked position.

16. The mechanism of claim 1, wherein the spacer member has first threads situated in the body interior for coupling with second threads of the spacing member.

17. The mechanism of claim 12, wherein the lock is slidable along the adjustment axis about a periphery of the mechanism body, such that a first axial position of the lock adjacent to the pair of resilient prongs denotes that the first set of spines and the second set of splines are in a fixed and locked engagement with one another while a second axial position of the lock away from the pair of resilient prongs denotes that the first set of spines and the second set of splines are in unlocked engagement with one another.

18. The mechanism of claim 1, wherein the mechanism body is anchored to the bracket by the connecting bushing.

19. A method for operating a cable adjustment mechanism for connecting a cable assembly comprising a cable to a bracket, the method comprising the steps of:
attaching a connecting bushing having a bracket connector to the bracket, the connecting bushing having a first body interior for receiving the cable there though;
attaching a cable connector of the connecting bushing to a mechanism body of the cable assembly. the mechanism body having a second body interior for receiving the cable there though, a first end, and a second end for receiving the connecting bushing, the first end opposed to the second end, the second body interior defining an adjustment axis;
coupling a spacing member at one end to a cable body of the cable assembly and coupling at another end with the mechanism body at the first end, the another end opposed to the one end, the spacing member having a third body interior for receiving the cable there through; and
positioning a lock for retaining a selected relative position on the mechanism body along the adjustment axis in order to retain a resultant separation distance between the connecting bushing and the cable body;
wherein the selected relative position is determined by adjusting a position of the coupling of the one end with respect to the first end along the adjustment axis prior to locking the selected relative position by the lock.

20. The method of claim 19, wherein the resultant separation distance is a result of relative rotation between the spacer member and the mechanism body.
